(19) United States
(12) Patent Application Publication
(10) Pub. No.: US 2010/0063956 A1
(43) Pub. Date: Mar. 11, 2010

(54) SYSTEM AND METHOD FOR IMPROVED PATIENT CARE AND PATIENT RECORD KEEPING

(76) Inventors: William Jay MCCALLUM, Fort Worth, TX (US); Jack Edward MCCALLUM, Fort Worth, TX (US)

Correspondence Address: HITCHCOCK EVERT LLP, P.O. BOX 131709, DALLAS, TX, 75313-1709, US

(21) Appl. No.: 12/557,752

(22) Filed: Sep. 11, 2009

Related U.S. Application Data
(60) Provisional application No. 61/096,142, filed on Sep. 11, 2008.

(51) Int. Cl. G06Q 50/00; G06N 5/02; G06Q 40/00; G06Q 10/00

(52) U.S. Cl. 706/52; 705/3

(57) ABSTRACT

The present invention relates generally to healthcare, and more specifically to a process for more completely and more accurately identifying and collecting health insurance plan members' medical diagnoses in compliance with the regulations of one or more health insurance payors such as, but not limited to, the United States Centers for Medicare and Medicaid Services' (“CMS”) Medicare Advantage regulations. In particular, the present invention provides a system, method, or computer program product whereby health insurance companies may ensure that their members are accurately diagnosed and that claims are accurately filed by reviewing existing member medical records to identify additional diagnoses which may have been treated but not specifically identified in claims filed by the members' health care provider.

### CROSS-REFERENCE TO RELATED APPLICATION

This application claims the benefit of priority from U.S. Provisional Application No. 61/096,142 filed on Sep. 11, 2008.

### FIELD OF THE INVENTION

The present invention relates generally to healthcare, and more specifically to a process for more completely and more accurately identifying and collecting health insurance plan members' medical diagnoses in compliance with the regulations of one or more health insurance payors such as, but not limited to, the United States Centers for Medicare and Medicaid Services' (“CMS”) Medicare Advantage regulations. In particular, the present invention provides a system, method, or computer program product whereby health insurance companies may ensure that their members are accurately diagnosed and that claims are accurately filed by reviewing existing member medical records to identify additional diagnoses which may have been treated but not specifically identified in claims filed by the members' health care provider.

The present invention further relates to the field of accurately gathering health insurance plan members' medical diagnoses to improve periodic, subsequent submissions to one or more health insurance payors, such as CMS. In so doing, the system, method, or computer program product of the present invention may improve the likelihood that a health insurance plan utilizing the present method is accurately reimbursed for the added expense of insuring members having the identified diagnoses.

The present invention further relates to a system, method, or computer program product for identifying and ranking health insurance plan members based on a statistical analysis of the probability that those members may have been incorrectly or incompletely diagnosed or that such diagnoses were incorrectly coded or claimed in the past.

The present invention further relates to a system, method, or computer program product for collecting health insurance plan members' medical records and performing a review of such records at a centralized location by a staff of medically-trained individuals.

In addition, the present invention relates to a system, method, or computer program product for processing data gathered during a review of health insurance plan members' medical records to determine a complete set of member diagnoses. The system, method, or computer program product of the present invention further processes this set of determined member health diagnoses to derive a set of standardized codes which represent the health conditions present in the member. Such codes are thereafter recognized by one or more insurance payors, such as, but not limited to, CMS, and for other purposes related, but not restricted, to management of risk, adjusted payments and patient care. This set of standardized codes, when received by an insurance payor, may then be used by the payor to determine appropriate payment rates to be paid to a health insurance plan as reimbursement to the health insurance plan for providing health insurance to the member represented by the set of standardized codes. In addition, the system, method, or computer program product of the present invention may also include elements designed to identify and quantify any change in reimbursement levels resulting from implementation of the method. For the purposes of description of the present invention, a health insurance plan may be the practitioner of the present invention. However, it should be noted that the practitioner of the present invention may be a third party practicing the present method for the benefit of a health insurance plan. Alternatively, the system, method, of computer program product may be used in a hybrid system, wherein a third party prepares the set of standardized codes, but then the health insurance plan submits the set of codes to the insurance payor.

The present invention further relates to the process of quality control within the insurance industry, as it also provides more accurate preparation of the set of standardized codes which represent member health conditions. By improving the accuracy of this standardized code set, the present invention may reduce the number of audit failures suffered by the practitioner of the present invention. Specifically, by improving the accuracy of the set of standardized codes, payors may identify fewer errors in a given audit of the invention practitioner's submissions to the payor.

The present invention further relates to a system, method, or computer program product for improving the accuracy and completeness of the diagnosis data which underlies the payor standardized codes. Specifically, the present invention relates to a system, method, or computer program product for reviewing the suitability of submitted codes vis-à-vis any requirements of the payor. For example, certain payors may accept diagnosis from only certain types of health care professionals; that is, a diagnosis from a primary care physician may be acceptable, where a diagnosis from a radiologist may not. In certain embodiments, the system, method, or computer program product of the present invention includes steps whereby at least some diagnoses are reviewed to ensure that they have been provided by payor-approved health care providers.

As another example, certain payors may require that certain formalities, such as the presence of a signature and date on each and every page of a member's chart, are met by the health care provider in recording diagnoses. Therefore, in certain embodiments of the present invention, the system, method, or computer program product of the present invention may include one or more steps addressing recurring failures in the preparation of the chart. Returning to the above example, if a particular health care provider is identified as repeatedly or routinely failing to follow the requirements of a particular payor, the system, method, or computer program product of the present invention may be utilized to address this issue and increase the likelihood that future records will be acceptable to the payor.

### BACKGROUND

The following background of the present invention will discuss generally the operation of CMS and how that organization both strives to provide up-to-date health care coverage while promoting quality care for health insurance plan members and accomplishes those goals, in part, by acting as a payor to health insurance plans. However, it should be understood that the discussion of CMS is by way of example only, and that the system, method, or computer program product of the present invention may be practiced in association with other payor entities.

In the United States, CMS administers plans known as Medicaid and Medicare, and within Medicare, a plan currently known as Medicare Advantage. Medicare Advantage operates as somewhat of a hybrid between a federally-provided health insurance plan known as Medicare Parts A and B, and a private health insurance plan as provided by health insurance plans other than Medicare. Under Medicare Advantage, health insurance plans register eligible individuals as members. CMS, through the Medicare Advantage plan, pays to a health insurance plan a dollar amount generally intended to subsidize the costs to the health insurance plan expected to be generated by a particular member, given the health conditions present in that member. In order for a health insurance plan to provide up-to-date and quality care for its members, CMS recognizes that the health insurance plan must be reimbursed for the extra costs associated with the improved care.

The amount paid to a health insurance plan by CMS will generally vary based upon a particular member's health conditions recognized in the CMS model in order to sufficiently reimburse the health insurance plan for the expenses expected to be incurred in providing health care to the particular member. Thus, CMS provides an incentive to health insurance plans to not only improve the care of their members, but also to insure members who would be otherwise uninsurable due to their health. In particular, as some health insurance plans may take the position that enrolling a member with a profile indicating some level of ill health may not be a sound financial decision given the expected costs to care for that member, CMS essentially makes such a member insurable by allocating to the health insurance plan some known level of reimbursement for both enrolling a member in poor health and improving the quality of care received by that member.

In treating members, health care providers generally will provide care based on a particular diagnosis. Ideally, these diagnoses are processed and are submitted by a health care plan to a payor such as CMS, which then reimburses the health care plan based on the diagnosis. However, for a variety of reasons, not all member diagnoses are effectively processed through the health care plan and on to CMS. For example, because health care providers are generally reimbursed based on treatments provided, rather than diagnoses, some health care providers may note such diagnoses on a member's chart, but because the diagnoses are not essential to the health care providers' reimbursement, not pass the diagnoses on to the health insurance plan.

Furthermore, in some situations health insurance plan payors, such as CMS, may impose stringent requirements on the type and sufficiency of documentation used to support a diagnosis. For example, the payors may require that each and every page, front and back, of a member's medical chart be signed, with credentials, and dated by the treating health care provider. Failure to sign and date the chart pages or even to append the credential “M.D.” to the provider's name, may render the chart pages insufficient documentation to support submission of a diagnosis to a payor.

Additionally, not all health care providers may render a diagnosis for the purposes of certain payor guidelines. For example, CMS does not accept diagnoses rendered by diagnostic radiologists. Thus, if a health insurance plan attempts to submit a set of codes to CMS based on a diagnosis made by a diagnostic radiologist, the submission could be rejected resulting in a financial penalty to the health insurance plan.

Finally, simple errors in coding, and the fact that members may switch health care providers, taking their records with them in the process, may also contribute to disconnects between the diagnoses made by a health care provider and the actual set of diagnosis codes reported by a health insurance plan to a payor.

Compounding the problems just described, health insurance plans, in order to be reimbursed under the diagnosis related risk adjustment methodology are required to submit all member diagnoses to Medicare annually. However, in the case of chronic conditions, there may be no clinically relevant reason for a healthcare provider to annually record that a member has such a condition. By way of example, if a diabetic member has had an amputation, this condition is persistent and recognized as having the potential to incur an expense. The condition is, therefore, assigned a value under the CMS model, but may not cause significant health issues from year-to-year. For this reason, a health insurance plan may properly note in a given year that a member is an amputee and be reimbursed from Medicare accordingly. However, through error or oversight, or simply because the treating physician has no reason to note the diagnosis in a given year, the amputation diagnosis may not be noted and may therefore be lost in any year, thereby preventing the health insurance plan from recovering a reimbursement from Medicare to which it is entitled for providing the enhanced care that may become necessary for that member.

However, under the current system promulgated by, for example, CMS, health insurance plans are not necessarily limited to seeking reimbursement only in a given year. Rather, the health insurance plans are allowed to seek certain retroactive reimbursements if it is discovered that a prior submission to CMS was in error and that the health insurance plan was actually entitled to a greater reimbursement. The system, method, or computer program product of the present invention addresses this opportunity for retroactive correction of previous submissions, thereby increasing the likelihood that the member will receive the greater quality of care suggested by CMS and also that the health insurance plan is accurately and completely reimbursed for insuring its members.

The present system, method, or computer program product further comprises the proper processing of data gathered so that it may be submitted to an appropriate payor, for example CMS.

### SUMMARY OF THE INVENTION

It is an object of the present invention to improve the quality of care for members of health insurance plans by completely and accurately identifying all medical diagnoses present in such members.

It is an object of the present invention to provide a system, method, or computer program product which overcomes the problems associated with the incomplete collection of member medical diagnoses and the attendant data processing required to accurately process such data and to prepare it for submission to an insurance payor.

It is a further object of the present invention to create comprehensive medical diagnoses for health insurance plan members.

It is a further object of the present invention to generate and process member health data, including medical diagnoses, in a manner which will improve accuracy in member profile submission to insurance payors.

It is a further object of the present invention to provide a system, method, or computer program product for identifying health insurance plan members whose medical profile, with regard to medical diagnoses, may be incompletely or inaccurately coded such that one or more medical diagnoses have not been noted or communicated to the health insurance plan and subsequently correcting such incomplete or inaccurate coding to ensure accurate creation and submission of member profiles to one or more insurance payors.

It is a further object of the present invention to identify certain health insurance plan members whose past member profiles may be inaccurate or incomplete with regard to medical diagnoses and correcting such past member profiles.

It is a further object of the present invention to provide a system, method, or computer program product for identifying and correcting errors in past member profiles so that the members may receive a better quality of care in the future.

It is a further object of the present invention to provide a system, method, or computer program product for identifying and correcting errors in past member profiles so that health insurance plans may be accurately reimbursed by one or more insurance payors for insuring particular health insurance plan members.

It is a further object of the present invention to provide a system, method, or computer program product for integrating member data in a computer database.

It is a further object of the present invention to provide a system, method, or computer program product for applying known payor guidelines, for example, but not limited to, Medicare Advantage Hierarchal Category Condition rules, disease interactions and diagnosis code mappings to a set of member diagnosis data.

It is a further object of the present invention to provide a system, method, or computer program product for gathering member health data and processing such data in a centralized location and by medically trained individuals for submission to an insurance payor system, for example, but not limited to, the Medicare Risk Adjustment Processing System.

### BRIEF DESCRIPTION OF THE DRAWINGS

FIG. 1 is a flowchart depicting the steps of the present invention.

### DETAILED DESCRIPTION

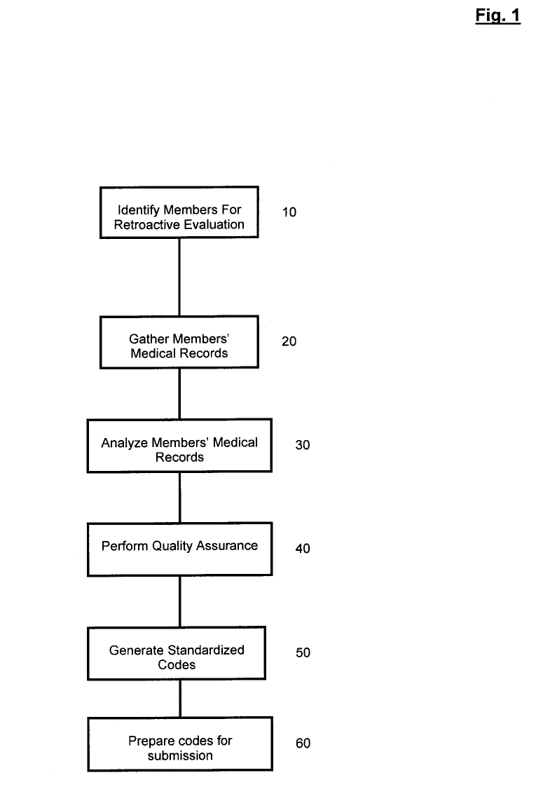

With reference to FIG. 1, the system, method, or computer program product of the present invention is a multi-step process beginning with the step 10 of identifying a set of health insurance plan members who are likely to be incompletely or inaccurately coded in a given year, thereby being preferred candidates for retroactive evaluation of the member's medical chart. Although ideally all members of a health insurance plan would be selected for evaluation, under some circumstances the practitioner of the present invention may elect not to retroactively evaluate all potential members' medical charts. Furthermore, the selection process may be used as a method for prioritizing those members most in need of retroactive evaluation.

The step 10 of identifying a set of health insurance plan members who are likely to be incompletely or inaccurately coded may be accomplished by a number of processes such as identifying high-risk or otherwise medically relevant member populations based on, for example, member age, sex, or medical history. Alternatively, or in conjunction with the preceding, a set of logic rules could be developed and employed utilizing some or all of these factors which would further refine the selection process. As will be appreciated by those skilled in the art, member characteristics can be used to predict the presence or absence of certain health conditions, or may indicate a likelihood that a member may have been inaccurately coded in a given year. In so doing, a practitioner of the present invention may identify a set of members who may be likely to have been incompletely or improperly coded in the past and which, therefore, may be in need of retroactive records evaluation. Such health insurance plan members may also represent opportunities for the health insurance plan covering the selected individuals to correct the amount it is reimbursed by its payor, for example, CMS.

For example, a practitioner of the present invention may select a group of members known to occupy a specific age bracket; live in a specific geographic area; be employed in a specific industry; or who may otherwise represent instances in which the health insurance plan has failed to recoup deserved reimbursements from an insurance payor.

In step 20, medical records for the members identified in step 10 are gathered. The step 20 gathering medical records may include gathering one or more medical charts and/or records from one or more physicians or other health care providers. Furthermore, additional records may be gathered from pharmacies, from the member's CMS or other payor eligibility records, and/or from CMS or another payor itself in the form of the member's Medicare or other healthcare records.

In step 30, the medical records gathered in step 20 are analyzed, in a preferred embodiment by one or more medically trained individuals located in a centralized reviewing location. The analysis of step 30 my include a review of the gathered medical records to identify specific treatments performed by a member's physician or other healthcare provider as well as diagnoses recorded within the member's chart. The analysis of the member's medical records may also incorporate application of standardized rules and guidelines designed to correlate recorded treatments with specific diagnoses. For example, the Medicare system described above promulgates a set of hierarchal rules, disease interactions and diagnosis code mappings which may be used to reliably associate specific treatments with diagnoses.

In step 40, a quality assurance step may be performed on the results of the analysis performed in step 30. In general, the goal of this step is to ensure that basic requirements are met by the analysis, and that any rules for identifying diagnoses. More specifically, the insurance payor may require specific documentation that meets both CMS and correct coding guidelines. In other words, the insurance payor may require a degree of evidence supporting a particular diagnosis, rather than a mere listing of the diagnosis. Thus, a more specific goal of step 40 is to increase the likelihood that any data gathered during the retroactive analysis of the member's medical records in step 30 will be ultimately accepted by the insurance payor.

In step 50, a set of standardized codes is generated based on the results of the analysis of step 30. Such standardized codes are generally established by the insurance payor and may be used to represent and convey information regarding the member's health condition to the insurance payor so that the insurance payor will reimburse the health insurance plan for insuring a member with a set of health conditions and for providing the expected level of care attendant to a member with those conditions.

Finally, in step 60, the set of standardized codes generated in step 50 is prepared for submission and submitted to the insurance payor. Preparation of the set of codes may include a number of steps designed to increase the likelihood that the codes will be accepted by the insurance payor. Thus, these steps may include, by way of example but not limitation, formatting the codes in a manner specified by the insurance payor and ensuring that all required data is present. In a case where the insurance payor is CMS, the formatted codes are generally known as a Risk Adjustment Processing System or RAPS file.

In one or more alternate embodiments of the present invention, the present system, method, or computer program product may include additional steps directed toward improving the quality of the submissions to the insurance payor, specifically by increasing the likelihood that such submissions would be found acceptable in a payor audit. For example, in an alternate embodiment, an additional step consisting of an electronic review is added. In this electronic review, the present system, method, or computer program product compares the set of prepared codes against an electronic claims file to ensure that the codes are each supported by a claim from an acceptable healthcare provider. Furthermore, some payor guidelines require that certain codes be supported by certain prerequisite codes. Thus, the electronic review may include a test of the set of submitted codes to ensure that all prerequisite codes have been included and are properly supported. Furthermore, the present system, method, or computer program product may also include an electronic review of the codes to examine the likelihood that the codes are supported by all necessary health care provider/member interactions.

Finally, in an alternate embodiment of the present invention, the present system, method, or computer program product may also include additional steps to identify certain errors made by health care providers which may render the member's medical charts insufficient to support the code set. By way of example, but not limitation, the present system, method, or computer program product may identify that certain healthcare providers fail to routinely sign and date medical charts. As an additional step, the practitioner of the present invention may use this data to assist the healthcare provider in properly documenting charts in the future, thereby increasing the likelihood that such charts would be acceptable in a payor audit.

The invention being thus described, it will be obvious that the same may be varied in many ways. Such variations are not to be regarded as a departure from the spirit and scope of the invention and all such modifications as would be obvious to one skilled in the art are intended to be included within the scope of the system, method, or computer program product described.

1. A system for managing health insurance plan member medical records, the system comprising:
a processor;
a memory; and
a management component stored in the memory, wherein said management component is executed by the processor to:
a) Identify at least one member of a health insurance plan suitable for evaluation;
b) Gather said at least one member's medical records;
c) Analyze said at least one member's medical records;
d) Perform a quality assurance review of said analysis;
e) Generate at least one standardized code representing the health condition of said at least one member; and
f) Prepare said at least one standardized code for submission to an insurance payor.

2. The system of claim 1 wherein said management component identifies said at least one member of said health insurance plan suitable for said evaluation based on a statistical analysis of the probability that said at least one member is one of incorrectly diagnosed and incompletely diagnosed.

3. The system of claim 1 wherein said management component identifies said at least one member of said health insurance plan suitable for said evaluation based on a statistical analysis of the probability that said at least one member has been one of incorrectly diagnosed and incompletely diagnosed in the past.

4. The system of claim 1 wherein said management component identifies said at least one member of said health insurance plan suitable for said evaluation based on identifying a limited set of members from a set of potential members, wherein said limited set of members comprises said at least one member.

5. The system of claim 1 wherein said management component identifies said at least one member of said health insurance plan suitable for said evaluation based on prioritizing a set of members most in need of retroactive evaluation.

6. The system of claim 1 wherein said management component identifies said at least one member of said health insurance plan suitable for said evaluation based on at least one of member age, member gender, and member medical history.

7. The system of claim 1 wherein said at least one member's medical records are gathered from at least one of a physician, a health care provider, a pharmacy, and said insurance payor.

8. A method for managing health insurance plan member medical records, the method comprising:
a) Identifying at least one member of a health insurance plan suitable for evaluation;
b) Gathering said at least one member's medical records;
c) Analyzing said at least one member's medical records;
d) Performing a quality assurance review of said analysis;
e) Generating at least one standardized code representing the health condition of said at least one member; and
f) Preparing said at least one standardized code for submission to an insurance payor.

9. The method of claim 8, further comprising performing a review of said at least one standardized code to verify that said at least one standardized code is supported by an appropriate medical claim.

10. The method of claim 8, further comprising performing a review of said at least one standardized code to verify that said at least one standardized code is supported by a prerequisite code as necessary.

11. The method of claim 8, further comprising performing a review of said at least one standardized code to verify that said at least one standardized code is supported by an interaction between a health care provider and said at least one member.

12. The method of claim 8, further comprising:
g) Identifying errors made by a health care provider in completing said at least one member's medical records; and
h) Assisting said health care provider in properly completing said at least one member's medical records in the future.

13. The method of claim 12, wherein identifying errors made by said health care provider in completing said at least one member's medical records comprises identifying an additional diagnosis which has been treated but remains unidentified in claims filed by said health care provider.

14. The method of claim 12, wherein assisting said health care provider in properly completing said at least one member's medical records in the future comprises correcting an incomplete coding to ensure accurate creation and submission of said at least one standardized code to said insurance payor.

15. A computer program product for managing health insurance plan member medical records, the computer program product comprising:
a computer readable storage medium storing computer executable program code that, when executed by a processor, causes said computer readable storage medium to perform a method comprising:
a) Identifying at least one member of a health insurance plan suitable for evaluation;
b) Gathering said at least one member's medical records;
c) Analyzing said at least one member's medical records;
d) Performing a quality assurance review of said analysis;
e) Generating at least one standardized code representing the health condition of said at least one member;
f) Preparing said at least one standardized code for submission to an insurance payor; and
g) Identifying and quantifying any change in a level of reimbursement based on submission of said at least one standardized code to said insurance payor.

16. The computer program product of claim 15 wherein analyzing said at least one member's medical records comprises identifying a treatment performed by said at least one member's healthcare provider, identifying a diagnosis recorded within said at least one member's medical records, and identifying a correlation between said treatment and said diagnosis.

17. The computer program product of claim 15 wherein performing said quality assurance review of said analysis of said at least one member's medical records is promoted by a staff of medically-trained individuals.

18. The computer program product of claim 15 wherein performing said quality assurance review of said analysis comprises improving the accuracy and completeness of the diagnosis data which underlies the payor's standardized codes.

19. The computer program product of claim 15 wherein performing said quality assurance review of said analysis comprises reviewing the suitability of a submitted code in relation to any requirement of said insurance payor.

20. The computer program product of claim 15 wherein preparing said at least one standardized code for submission to an insurance payor comprises formatting the at least one standardized code in a manner specified by said insurance payor and ensuring that all required data is present.
